(19) United States
(12) Patent Application Publication
(10) Pub. No.: US 2026/0273802 A1
(43) Pub. Date: Sep. 17, 2026

(54) SCALE UP PROCESS TEXTILE TO TEXTILE PROCESSING OF POLYESTER

(71) Applicant: 14787285 Canada Inc. dba Nuria Scientific, Thorold (CA)

(72) Inventors: Nicholas Ledra, St Catherines (CA); Wankei Wan, Thorold (CA)

(21) Appl. No.: 19/557,880

(22) Filed: Mar. 5, 2026

Related U.S. Application Data
(60) Provisional application No. 63/771,660, filed on Mar. 14, 2025.

(51) Int. Cl. B29B 17/02; B29K 67/00; B29K 105/26

(52) U.S. Cl. CPC B29B 17/02; B29B 2017/0293; B29K 2067/003; B29K 2105/26

(57) ABSTRACT

The present disclosure provides a system for textile-to-textile processing of polyester. The system comprises a dissolution unit which receives a waste textile material and a dissolution solvent for selective dissolution of a polyester fraction. The system further comprises a downstream processing unit which receives the dissolution solvent from the dissolution unit. The downstream processing unit comprises a precipitation chamber which receives a precipitation solvent to precipitate the dissolved polyester. Additionally, the downstream processing unit comprises a drying unit which dries the precipitated polyester.

### CROSS REFERENCE TO RELATED APPLICATION

This application claims benefit of priority to U.S. Provisional Application Serial Number 63/771,660, filed March 14, 2025, the content of which is hereby incorporated by reference in its entirety.

### TECHNICAL FIELD

The present disclosure generally relates to textile recycling systems. Further, the present disclosure particularly relates to a system for textile-to-textile processing of polyester.

### BACKGROUND

The textile industry generates a significant volume of waste materials due to mass production and short product lifecycles. Textile waste comprises discarded garments, production offcuts, and post-consumer fabric waste, which contribute to environmental pollution. Conventional waste management practices involve landfill disposal or incineration, both of which are associated with negative environmental impacts. Incineration releases harmful emissions, while landfill disposal results in prolonged decomposition periods, leading to greenhouse gas emissions. Recycling methods have been developed to mitigate textile waste; however, challenges persist in efficiently reintegrating textile materials into the production cycle.

Various techniques have been implemented to recycle textile waste and recover raw materials. One widely adopted approach involves converting plastic waste, comprising polyethylene terephthalate (PET) bottles, into synthetic fibres through depolymerization and repolymerization processes. Such an approach facilitates the reuse of plastic waste in textile manufacturing. However, the recycling technique does not address the issue of textile waste, as textile fibres originating from natural or blended materials are not efficiently processed through depolymerization. Consequently, significant portions of textile waste continue to be discarded, exacerbating environmental concerns.

Another known approach involves mechanical recycling methods, where textile waste undergoes shredding and re-spinning processes to create recycled yarns. The technique allows partial reuse of textile materials; however, mechanical recycling degrades fibre quality, reducing the durability and strength of the resulting fabric. Furthermore, additional virgin fibres are required to maintain fabric integrity, limiting the extent of waste reduction. Dye removal and fibre separation further complicate mechanical recycling, resulting in limited applicability for mixed-fibre textiles.

Chemical recycling has been explored to separate and regenerate textile fibres through solvent-based or enzymatic treatments. The approach facilitates fibre recovery by dissolving synthetic and natural fibres selectively. However, chemical recycling processes require substantial chemical inputs and energy consumption, leading to secondary environmental concerns. Moreover, the separation of blended fabrics remains inefficient, restricting the scalability of chemical recycling for diverse textile compositions.

Current textile waste recycling solutions remain inadequate in fully addressing textile waste accumulation. Plastic-based recycling primarily targets non-textile waste streams, failing to recover textile-specific materials. Mechanical recycling degrades fibre properties, while chemical recycling is constrained by high operational costs and energy requirements. Additionally, mixed-material textiles pose challenges in all known recycling methodologies, contributing to continued landfill accumulation and greenhouse gas emissions.

In light of the above discussion, there exists an urgent need for solutions that overcome the problems associated with conventional systems and techniques for recovering waste textile elements to be put back into the supply chain to make future garments.

### SUMMARY

An objective of the present disclosure is to provide a system for textile-to-textile processing of polyester to facilitate the selective dissolution and recovery of polyester from waste textile material while enabling solvent recovery.

In an aspect, the present disclosure provides a system for textile-to-textile processing of polyester. The system comprises a dissolution unit which receives a waste textile material and a dissolution solvent for selective dissolution of a polyester fraction. The system further comprises a downstream processing unit which receives the dissolution solvent from the dissolution unit. The downstream processing unit comprises a precipitation chamber which receives a precipitation solvent to precipitate the dissolved polyester. Additionally, the downstream processing unit comprises a drying unit which dries the precipitated polyester.

Furthermore, the dissolution unit maintains a temperature condition ranging from -10°C to 80°C under standard pressure to optimize the selective dissolution of polyester. The dissolution solvent comprises a mixture of halide-based acetic acid and an organic polar solvent selected from dimethylformamide (DMF), dimethyl sulfoxide (DMSO), and N-methyl-2-pyrrolidone (NMP). Further, the dissolution unit is associated with an agitator to improve solubility and dissolution efficiency.

The precipitation chamber comprises a filtration unit to separate precipitated polyester from the precipitation solvent. Further, the drying unit comprises a vacuum dryer and a freeze dryer to remove residual solvent traces from the precipitated polyester. Additionally, a solvent recovery unit is provided to recover the dissolution solvent and the precipitation solvent. Furthermore, the dissolution unit selectively dissolves used polyester/PET polyester material and cotton/polyester blended fabric comprising polyester, acrylic, wool, or cotton to preserve textile-ready materials.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein.

Embodiments of the present disclosure will now be described, by way of example only, with reference to the following diagrams.

FIG. 1 illustrates a system 100 for textile-to-textile processing of polyester, in accordance with various implementations of the present disclosure; and

FIG. 2 illustrates a sequential diagram of the system 100 for textile-to-textile processing of polyester, in accordance with embodiments of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

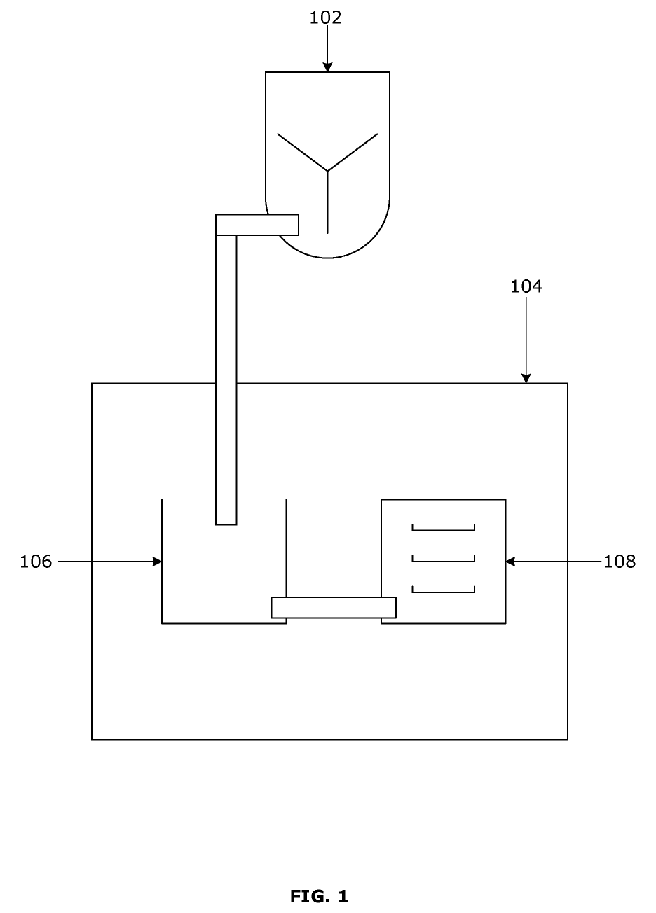

FIG. 1 illustrates a system 100 for textile-to-textile processing of polyester, in accordance with various implementations of the present disclosure. The system 100 for textile-to-textile processing of polyester comprises a dissolution unit 102 to receive a waste textile material and a dissolution solvent for selective dissolution of a polyester fraction. The dissolution unit 102 comprises an inlet section to facilitate the controlled introduction of the waste textile material. A solvent dispensing mechanism within the dissolution unit 102 regulates the introduction of the dissolution solvent to optimize interaction with the waste textile material. A reaction chamber within the dissolution unit 102 maintains conditions favorable for dissolving the polyester fraction while minimizing degradation of non-polyester components. A temperature control assembly within the dissolution unit 102 maintains a temperature range between -10°C and 80°C under standard pressure to optimize dissolution kinetics. An agitator assembly within the dissolution unit 102 improves solvent interaction by promoting uniform exposure of the waste textile material to the dissolution solvent. A filtration interface within the dissolution unit 102 separates undissolved residues from the dissolution solvent before transferring to a downstream processing unit 104.

In an embodiment, the downstream processing unit 104 receives the dissolution solvent containing the dissolved polyester from the dissolution unit 102. The downstream processing unit 104 comprises a controlled transfer conduit which regulates the flow of the dissolution solvent to prevent premature precipitation of the polyester fraction. A fluid distribution assembly within the downstream processing unit 104 assures uniform delivery of the dissolution solvent to a precipitation chamber 106. A structural construction within the downstream processing unit 104 supports integration with the precipitation chamber 106 and a drying unit 108 to facilitate sequential processing of the dissolved polyester.

In an embodiment, the precipitation chamber 106 receives a precipitation solvent to precipitate the dissolved polyester. The precipitation chamber 106 comprises an inlet manifold for controlled introduction of the precipitation solvent to induce polymer aggregation. A reaction enclosure within the precipitation chamber 106 maintains conditions which promote controlled precipitation, comprising solvent ratios, agitation, and temperature parameters. A filtration interface within the precipitation chamber 106 facilitates separation of the precipitated polyester from the precipitation solvent. A discharge outlet within the precipitation chamber 106 transfers the separated polyester to the drying unit 108.

In an embodiment, the drying unit 108 dries the precipitated polyester to remove residual solvent traces. The drying unit 108 comprises a vacuum dryer which applies reduced pressure to facilitate solvent evaporation. A freeze dryer within the drying unit 108 subjects the precipitated polyester to controlled sublimation conditions for moisture removal. A containment structure within the drying unit 108 maintains the integrity of the drying process while minimizing contamination risks. A discharge interface within the drying unit 108 enables collection of the dried polyester for subsequent processing.

In an exemplary aspect, the system 100 for textile-to-textile processing of polyester is utilized in an industrial textile recycling facility to recover polyester from discarded garments and post-industrial textile waste. A batch of 50 kilograms of mixed textile waste, comprising polyester-based garments and cotton-polyester blended fabrics, is introduced into the dissolution unit 102. The dissolution solvent comprising a mixture of halide-based acetic acid and dimethyl sulfoxide (DMSO) in a ratio of 3:1 is added to the dissolution unit 102 at a volume of 100 liters. The dissolution unit 102 maintains a temperature of 60°C under standard atmospheric pressure while an agitator operating at 500 revolutions per minute (RPM) continuously stirs the mixture to improve the dissolution process. Over a period of 120 minutes, the polyester fraction is selectively dissolved, while non-polyester fibers, for example cotton and wool remain undissolved and are subsequently filtered out. The downstream processing unit 104 receives the dissolution solvent containing the dissolved polyester fraction from the dissolution unit 102. The dissolution solvent is transferred through a conduit into the precipitation chamber 106, where the precipitation solvent consisting of 150 liters of chilled ethanol at 5°C is introduced. Upon mixing, the ethanol induces precipitation of the dissolved polyester, forming solid polyester particles. A controlled mixing mechanism in the precipitation chamber 106 operates at a speed of 200 RPM for 30 minutes to assure uniform precipitation. The precipitated polyester particles, averaging 500 microns in size, are then separated from the precipitation solvent using a filtration unit which employs a membrane filtration technique with a pore size of 0.2 microns. The drying unit 108 receives the precipitated polyester and subjects the precipitated polyester to a drying process to remove residual solvent traces. A vacuum dryer operates at a pressure of 10 millibars and a temperature of 50°C for 90 minutes, followed by a freezing dryer which subjects the polyester to a sublimation process at -40°C under a vacuum of 5 millibars for 120 minutes. The dried polyester, recovered in granular form with a purity of 98%, is collected for reuse in textile manufacturing.

In an embodiment, the dissolution unit 102 may maintain a temperature range ranging from -10°C to 80°C (selected from distinct ranges such as -10°C to 20°C, 21°C to 40°C, 41°C to 50°C and 51°C to 80°C) under standard pressure to optimize the selective dissolution of polyester. The temperature regulation within the dissolution unit 102 influences the solubility and separation efficiency of the polyester fraction. A heating and cooling mechanism, including resistive heating elements and coolant circulation systems, enables temperature modulation within the predetermined range. A temperature sensor is positioned within the dissolution unit 102 to monitor thermal variations, and an automated control circuit adjusts heating or cooling based on predefined parameters. For example, when processing a batch of 50 kilograms of polyester-based textile waste, the dissolution unit 102 is maintained at 60°C to accelerate dissolution without degrading fiber properties. When working with blended fabric containing cotton or acrylic fibers, a lower temperature of 30°C is applied to prevent excessive degradation of non-polyester components. The dissolution unit 102 incorporates an insulation layer to minimize heat loss and maintain consistent operating conditions.

In an embodiment, the dissolution solvent may comprise a mixture of halide-based acetic acid and an organic polar solvent selected from dimethylformamide (DMF), dimethyl sulfoxide (DMSO), and N-methyl-2-pyrrolidone (NMP). The dissolution solvent interacts selectively with polyester fibers while minimizing the impact on non-polyester fractions present in blended textiles. For instance, a typical solvent mixture includes halide-based acetic acid at a concentration of 60% by volume and an organic polar solvent at 40% by volume. The dissolution solvent is introduced into the dissolution unit 102 through an inlet system, allowing controlled distribution over the textile waste material. In a batch process involving 100 liters of dissolution solvent, polyester fractions dissolve within 120 minutes under controlled agitation and temperature conditions. The solvent composition is selected based on compatibility with polyester molecular structures and efficiency in phase separation during subsequent precipitation stages.

In an embodiment, the dissolution unit 102 may be associated with an agitator to improve solubility and dissolution efficiency. The agitator may comprise a mechanical stirrer, an ultrasonic agitation system, or a rotary impeller. For instance, the agitation mechanism operates at variable speeds ranging from 200 to 1000 RPM, assuring uniform solvent distribution and fiber exposure to the dissolution medium. In a batch process utilizing 50 kilograms of textile waste, a rotary impeller set at 500 RPM reduces dissolution time by 30% compared to static immersion. The agitator is positioned at the base of the dissolution unit 102 to facilitate solvent circulation and prevent sedimentation of undissolved materials. In some cases, an ultrasonic agitation system is employed to improve molecular dispersion, particularly when processing textiles with high-density polyester compositions.

In an embodiment, the precipitation chamber 106 may comprise a filtration unit to separate precipitated polyester from the precipitation solvent. The filtration unit utilizes membrane filtration, centrifugation, or gravity-based separation to isolate polyester solids. For example, a membrane filter with a pore size of 0.2 microns is positioned within the precipitation chamber 106 to capture precipitated polyester particles while allowing precipitation solvent to pass through. In an industrial-scale process handling 100 liters of precipitation solvent, the filtration unit achieves a separation efficiency of 98% within 30 minutes. A controlled vacuum pressure system aids in removing residual solvent from the filtered polyester solids, improving recovery rates.

In an embodiment, the drying unit 108 may comprise a vacuum dryer and a freeze dryer to remove residual solvent traces from the precipitated polyester. For instance, the vacuum dryer operates at a pressure of 10 millibars and a temperature of 50°C, enabling solvent evaporation at reduced thermal stress. The freeze dryer subjects the precipitated polyester to sublimation conditions at -40°C under a vacuum of 5 millibars, effectively removing trapped solvent molecules. In a drying cycle processing 20 kilograms of precipitated polyester, the vacuum dryer removes 85% of residual solvent within 90 minutes, while the freeze dryer completes the remaining solvent removal in an additional 120 minutes. A controlled exhaust system collects and condenses the extracted solvent vapors, preventing atmospheric release.

In an embodiment, a solvent recovery unit may be provided to recover the dissolution solvent and the precipitation solvent. The solvent recovery unit operates through a distillation process, separating solvent components based on boiling points. A fractionation column enables selective condensation, allowing halide-based acetic acid and organic polar solvents to be collected separately. For example, in a recovery process handling 200 liters of mixed solvents, the solvent recovery unit achieves a 90% solvent reclamation rate within a four-hour cycle. A filtration mechanism further purifies recovered solvents to remove contaminants and by-products, assuring reusability in subsequent dissolution and precipitation cycles.

In an embodiment, the dissolution unit 102 may selectively dissolve used polyester/PET polyester material and cotton/polyester blended fabric comprising polyester, acrylic, wool, or cotton to preserve textile-ready materials. The selective dissolution process prioritizes polyester solubilization while allowing non-polyester fibers to remain intact. For example, in an industrial process handling 70 kilograms of blended textile waste, the dissolution unit 102 is maintained at 50°C with an agitation speed of 600 RPM. Under these conditions, 95% of polyester fibers dissolve within 90 minutes, while cotton, wool, and acrylic fibers are subsequently separated through filtration. The dissolution unit 102 applies controlled solvent exposure to minimize fiber degradation, facilitating the potential reuse of non-polyester components in alternative applications.

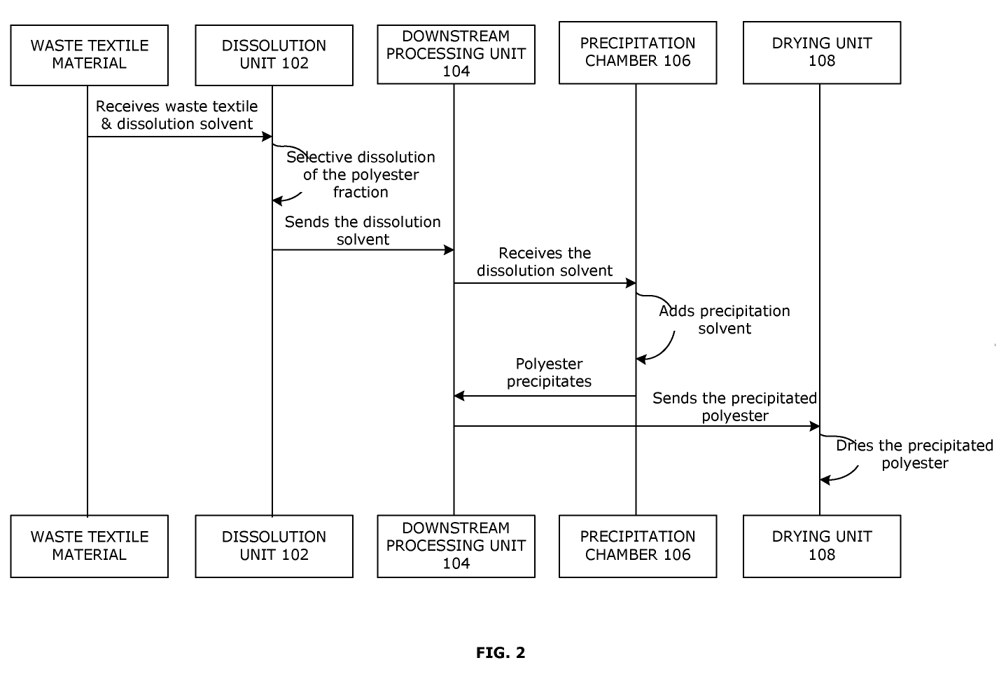

FIG. 2 illustrates a sequential diagram of the system 100 for textile-to-textile processing of polyester, in accordance with embodiments of the present disclosure. The system 100 for textile-to-textile processing of polyester initiates with waste textile material being introduced into a dissolution unit 102, where a dissolution solvent is applied for selective dissolution of the polyester fraction. The dissolution unit 102 facilitates uniform interaction between the solvent and textile fibers, assuring efficient polyester dissolution. The dissolution solvent containing the dissolved polyester is then transferred to a downstream processing unit 104. Within the downstream processing unit 104, a precipitation chamber 106 receives a precipitation solvent, which induces phase separation, leading to polyester precipitation. The precipitated polyester is subsequently transferred to a drying unit 108, where residual solvent traces are removed through vacuum drying and freeze drying. The drying unit 108 processes the polyester under controlled temperature and pressure conditions to achieve solvent-free polyester recovery. The dried polyester is then collected for reuse in textile manufacturing applications.

In an embodiment, the system 100 for textile-to-textile processing of polyester, addressing the global problem of textile waste by selectively dissolving used polyester/PET polyester material and cotton/polyester blended fabric while preserving textile-ready materials. The dissolution unit 102 receives a waste textile material and a dissolution solvent comprising a mixture of halide-based acetic acid and an organic polar solvent selected from DMF, DMSO, and NMP. The dissolution unit 102 maintains a temperature condition ranging from -10°C to 80°C under standard pressure to optimize the selective dissolution of polyester. The dissolution unit 102 is associated with an agitator to improve solubility and dissolution efficiency. The downstream processing unit 104 receives the dissolution solvent from the dissolution unit 102, wherein the downstream processing unit 104 comprises the precipitation chamber 106 and the drying unit 108. The precipitation chamber 106 receives the precipitation solvent to precipitate the dissolved polyester and comprises a filtration unit to separate precipitated polyester from the precipitation solvent. The drying unit 108 comprises a vacuum dryer and a freeze dryer to remove residual solvent traces from the precipitated polyester. A solvent recovery unit recovers the dissolution solvent and the precipitation solvent, minimizing solvent usage while assuring efficient processing. The system 100 produces polyester PET of suitable molecular weight to be spun back into textile, reducing textile waste, lowering carbon footprint, and promoting sustainability. The process allows waste textile elements to be put back into the supply chain to make future garments, overcoming deficiencies in existing recycling methods which primarily repurpose plastic waste without addressing textile-specific recycling.

What is claimed is:

1. A system for textile-to-textile processing of polyester, comprising:
a dissolution unit configured to receive a waste textile material and a dissolution solvent for selective dissolution of a polyester fraction;
a downstream processing unit configured to receive the dissolution solvent from the dissolution unit, wherein the downstream processing unit comprises:
a precipitation chamber configured to receive a precipitation solvent to precipitate the dissolved polyester; and
a drying unit configured to dry the precipitated polyester.

2. The system of claim 1, wherein the dissolution unit is configured to maintain temperature condition ranging from -10°C to 80°C under standard pressure to optimize the selective dissolution of polyester.

3. The system of claim 1, wherein the dissolution solvent comprises a mixture of halide-based acetic acid and an organic polar solvent selected from the group comprising: dimethylformamide (DMF), dimethyl sulfoxide (DMSO), and N-methyl-2-pyrrolidone (NMP).

4. The system of claim 1, wherein the dissolution unit is associated with an agitator to enhance solubility and dissolution efficiency.

5. The system of claim 1, wherein the precipitation chamber comprises a filtration unit to separate precipitated polyester from the precipitation solvent.

6. The system of claim 1, wherein the drying unit comprises a vacuum dryer and a freeze dryer to remove the residual solvent traces from the precipitated polyester.

7. The system of claim 1, further comprising a solvent recovery unit to recover the dissolution solvent and the precipitation solvent.
